(19) United States
(12) Patent Application Publication
(10) Pub. No.: US 2009/0268304 A1
(43) Pub. Date: Oct. 29, 2009

(54) UNITARY COMPOSITE LENS

(75) Inventors: Hou-Yao Lin, Tu-Cheng (TW); Sheng-Jung Yu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/274,492

(22) Filed: Nov. 20, 2008

(30) Foreign Application Priority Data
Apr. 25, 2008 (CN) 200810301318.8

(51) Int. Cl. G02B 3/00

(52) U.S. Cl. 359/642

(57) ABSTRACT

A unitary composite lens includes a first lens portion, a second lens portion spaced from the first lens portion, and a connecting portion connecting the first lens portion and the second lens portion. The second lens portion is optically aligned with the first lens portion. The first lens portion, the second lens portion and the connecting portion are comprised of a same material.

### BACKGROUND

1. Technical Field

The present invention relates to optical imaging devices, and particularly, to a unitary composite lens.

2. Description of Related Art

With the development of optical imaging technology, electronic devices, such as digital cameras and mobile phones, adopting lens modules have been introduced and marketed.

Generally, a lens module includes a barrel and a lens assembly (e.g., a first and a second lenses) received in the barrel. In assembly, the first and the second lenses are sequentially placed into the barrel. Because of the parameter difference between the first and the second lenses, position/angle of the second lens may tilt relative to the first lens after the second lens coupled to the first lens. Accordingly, imaging quality of the lens module deteriorates, and such a lens module is unsatisfactory.

Therefore, a new unitary composite lens is desired to overcome the above mentioned problems.

### SUMMARY

A unitary composite lens includes a first lens portion, a second lens portion spaced from the first lens portion, and a connecting portion connecting the first lens portion and the second lens portion. The second lens portion is optically aligned with the first lens portion. The first lens portion, the second lens portion and the connecting portion are comprised of a same material.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, cross-sectional view of a unitary composite lens according to a first embodiment.

FIG. 2 is a schematic, plan view of the unitary composite lens depicted in FIG. 1.

FIG. 3 is a schematic, cross-sectional view of a unitary composite lens according to a second embodiment.

FIG. 4 is a schematic, cross-sectional view of a unitary composite lens according to a third embodiment.

FIG. 5 is a schematic, cross-sectional view of a lens module according to a fourth embodiment.

### DETAILED DESCRIPTION OF THE EMBODIMENTS

Embodiments will now be described in detail below with reference to the drawings.

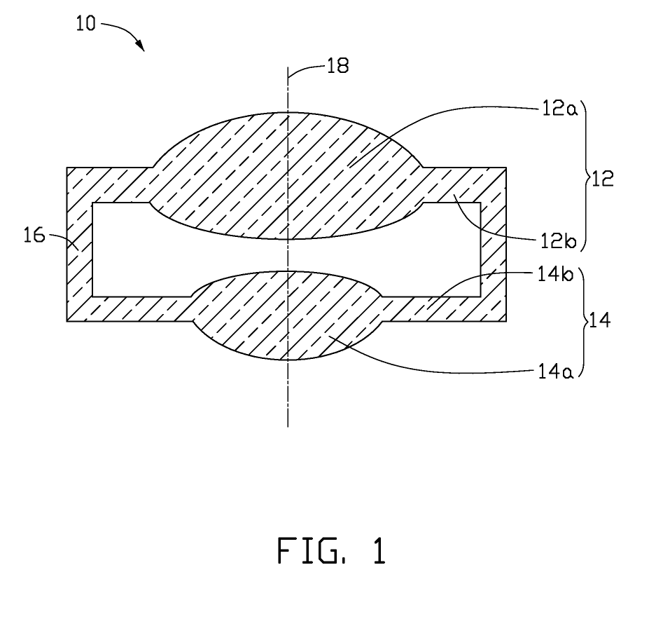

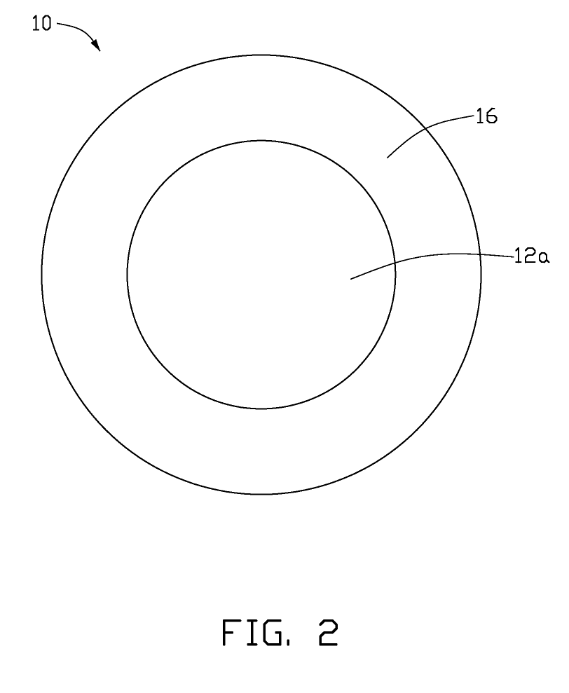

Referring to FIGS. 1 and 2, a unitary composite lens 10 according to a first embodiment is shown. The unitary composite lens 10 includes a first lens portion 12, a second lens portion 14, and a connecting portion 16. The first lens portion 12, the second lens portion 14, and the connecting portion 16 are integrally formed. An optical axis 18 of the first lens portion 12 aligns with an optical axis (not labeled) of the second lens portion 14. The first lens portion 12 includes a first central optically active part 12a and a first peripheral optically inactive part 12b surrounding the first optically active part 12a. The second lens portion 14 includes a second central optically active part 14a and a second peripheral optically inactive part 14b surrounding the second central optically active part 14a. The connecting portion 16 is interconnected between the first optically inactive part 12b and the second optically inactive part 14b. The connecting portion 16 extends along the optical axis 18.

Due to the first lens portion 12, the second lens portion 14, and the connecting portion 16 being integrally formed, the position of the lenses 14, 16 are stable and can be accurately positioned into the barrel. The optical axis 18 of the first lens portion 12 is in good alignment with that of the second lens portion 14.

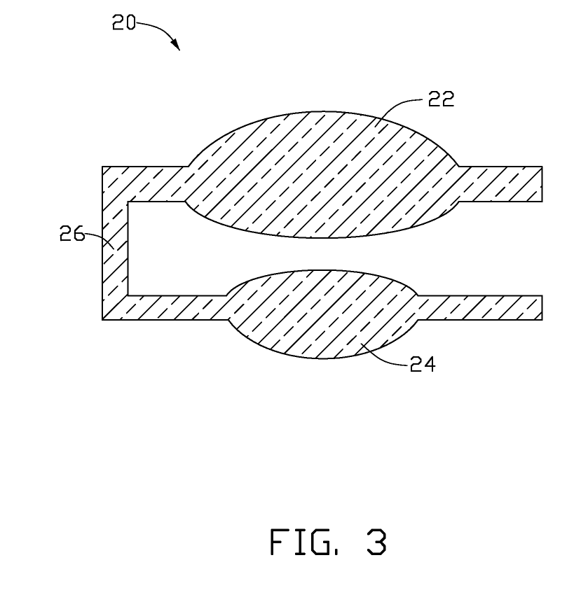

Referring to FIG. 3, a unitary composite lens 20 in accordance with a second embodiment is shown. The unitary composite lens 20 includes a first lens portion 22, a second lens portion 24, and a connecting portion 26. The unitary composite lens 20 is similar to the unitary composite lens 10 except that the connecting portion 26 has a different structure from the connecting portion 16. The connecting portion 26 connects only a side of the first lens portion 22 to a side of the second lens portion 24. It should be noted that the unitary composite lens 20 may include a plurality of spaced connecting portion 26.

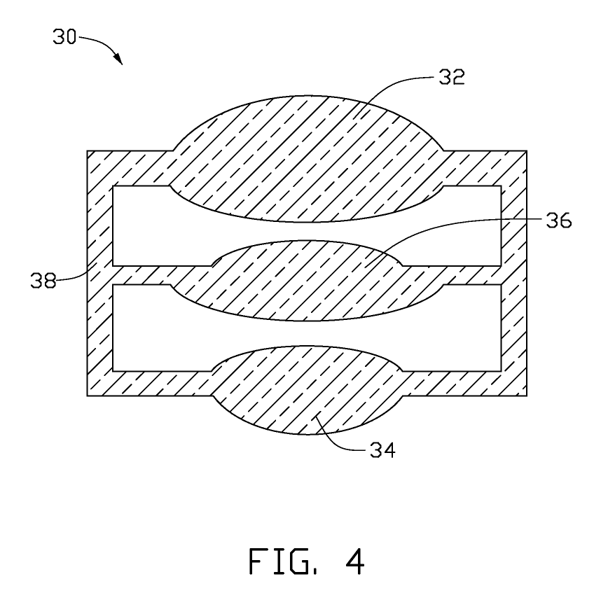

Referring to FIG. 4, a unitary composite lens 30 according to a third embodiment is shown. The unitary composite lens 30 is similar to the unitary composite lens 10 except that the unitary composite lens 30 further includes a third lens portion 36. The unitary composite lens 30 includes a first lens portion 32, a second lens portion 34, the third lens portion 36, and a connecting portion 38.

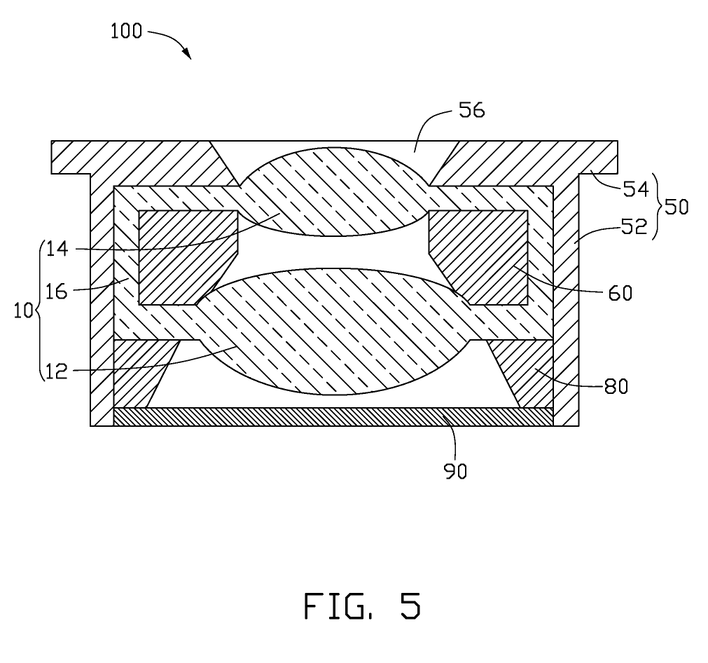

Referring to FIG. 5, a lens module 100 in accordance with a fourth embodiment is shown. The lens module 100 includes the unitary composite lens 10, a barrel 50, spacers 60, 80, and an optical filter 90.

The barrel 50 includes a main body 52 and a supporting part 54. The supporting part 54 has an opening 56 defined at a central portion therein. The main body 52 is a hollow cylinder. The unitary composite lens 10, the spacers 60, 80, and the optical filter 90 are received in the main body 52. The spacer 60 is sandwiched between the first lens portion 14 and the second lens portion 16. The spacer 80 is sandwiched between the unitary composite lens 10 and the optical filter 90. Alternatively, the unitary composite lens 10 of the lens module can be substituted by the unitary composite lens 20 or 30.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A unitary composite lens comprising:
a first lens portion;
a second lens portion spaced from the first lens portion, the second lens portion optically aligned with the first lens portion; and
a connecting portion connecting the first lens portion and the second lens portion, the first lens portion, the second lens portion and the connecting portion being comprised of a same material.

2. The unitary composite lens as claimed in claim 1, being comprised of plastic or glass.

3. The unitary composite lens as claimed in claim 1, further comprising a third lens portion optically aligned with the first lens portion and the second lens portion, wherein the connecting portion connects the second lens portion and the third lens portion.

4. A unitary composite lens with an optical axis, comprising:
a first lens portion;
a second lens portion spaced from the first lens portion, the first lens portion and the second lens portion being arranged along the optical axis; and
a connecting portion connecting the first lens portion and the second lens portion, the first lens portion, the second lens portion and the connecting portion being comprised of a same material.

5. The unitary composite lens as claimed in claim 4, being comprised of plastic or glass.

6. The unitary composite lens as claimed in claim 4, further comprising a third lens portion, wherein the first lens portion, the second lens portion and the third lens portion are arranged along the optical axis in the order written, the connecting portion connects the second lens portion and the third lens portion.

7. A unitary composite lens comprising:
a first lens portion comprising a first central optically active part and a first peripheral optically inactive part surrounding the central optically active part;
a second lens portion spaced from the first lens portion, the second lens portion comprising a second central optically active part optically aligned with the first central optically active part and a second peripheral optically inactive part surrounding the second central optically active part; and
a connecting portion interconnected between the first peripheral optically inactive part and the second peripheral optically inactive part, the first lens portion, the second lens portion and the connecting portion being comprised of a same material.

8. The unitary composite lens as claimed in claim 7, being comprised of plastic or glass.
